(19) United States
(12) Patent Application Publication
(10) Pub. No.: US 2021/0071909 A1
(43) Pub. Date: Mar. 11, 2021

(54) Portable Heater

(71) Applicant: Pinnacle Climate Technologies, Eden Prairie, MN (US)

(72) Inventor: Sukru Erisgen, Eden Prairie, MN (US)

(21) Appl. No.: 16/564,371

(22) Filed: Sep. 9, 2019

(51) Int. Cl. F24H 3/04; F24H 9/00

(52) U.S. Cl. CPC F24H 3/0417; F24H 9/0052; F24H 3/0488

(57) ABSTRACT

A portable heater with features to prevent or minimize fuel gelling is disclosed. The portable heater can include a fuel tank, a burner assembly, a combustion chamber tube, and a fuel line extending between the fuel tank and the burner assembly. In one aspect, at least a portion of the fuel line is heated by the combustion chamber tube. The fuel line can extend along an exterior side of the combustion chamber tube. Where the combustion chamber tube is an inner tube disposed within an outer combustion chamber tube, the fuel line can extend within an interstitial space defined between the combustion chamber inner and outer tubes. A preheater may also be provided in the fuel tank to preheat fuel proximate an inlet of the fuel line.

### BACKGROUND

Portable heaters, for example, portable kerosene heaters having an integrated fuel tank, are known. Portable heaters are used for a variety of purposes, such as providing heating on construction sites when outdoor ambient temperatures are below acceptable temperatures for the workers and/or the materials and systems being installed. During exceptionally cold periods, the fuel stored in the fuel tank can become gelled which can either prevent the heater from operating or, at a minimum, increase the difficulty in starting the heater. Some approaches for reducing or eliminating gelling in portable heaters include the use of specially blended fuels and additives. Improvements are desired.

### SUMMARY

A portable heater is disclosed. The portable heater can include a fuel tank, a burner assembly, and a combustion chamber tube, and a fuel line extending between the fuel tank and the burner assembly, wherein, during operation, at least a portion of the fuel line is heated by the combustion chamber tube.

In some examples, the at least a portion of the fuel line extends along an exterior side of the combustion chamber tube.

In some examples, the at least a portion of the fuel line is in direct contact with the exterior side of the combustion chamber tube.

In some examples, the at least a portion of the fuel line is spaced from the exterior side of the combustion chamber tube.

In some examples, the combustion chamber tube is an inner tube disposed within an outer combustion chamber tube, and wherein the at least a portion of the fuel line extends in an interstitial space defined between the combustion chamber inner and outer tubes.

In some examples, a first segment of the at least a portion of the fuel line extends in a direction parallel to a length of the combustion chamber tube.

In some examples, the fuel line includes two or more first segments.

In some examples, the fuel line includes four first segments.

In some examples, the portable heater further includes a fuel intake tube located within an interior volume of the fuel tank and including a preheater located within the fuel tank interior volume, the fuel intake tube being in fluid communication with the fuel line, the preheater including a heating element proximate an inlet end of the fuel intake tube.

In some examples, the preheater heating element is an electric heating element.

A portable kerosene heater is disclosed. The portable kerosene heater can include a fuel tank for storing kerosene, a heater assembly supported to the fuel tank, the heater assembly including a burner assembly and a combustion chamber tube, a fuel line extending between the fuel tank and the burner assembly and along an exterior side of the combustion chamber tube.

In some examples, at least a portion of the fuel line is in direct contact with the exterior side of the combustion chamber tube.

In some examples, at least a portion of the fuel line is spaced from the exterior side of the combustion chamber tube.

In some examples, the combustion chamber tube is an inner tube disposed within an outer combustion chamber tube, and wherein at least a portion of the fuel line extends in an interstitial space defined between the combustion chamber inner and outer tubes.

In some examples, a first segment of the at least a portion of the fuel line extends in a direction parallel to a length of the combustion chamber tube.

In some examples, the fuel line includes two or more first segments.

In some examples, the fuel line includes four first segments.

In some examples, the portable kerosene heater further includes a fuel intake tube located within an interior volume of the fuel tank and including a preheater located within the fuel tank interior volume, the fuel intake tube being in fluid communication with the fuel line, the preheater including a heating element proximate an inlet end of the fuel intake tube.

In some examples, the preheater heating element is an electric heating element.

A portable heater is disclosed. The portable heater can include a fuel tank defining an interior volume for storing a liquid fuel, a fuel intake tube located within the interior volume of the fuel tank, the fuel intake tube having an inlet end, a burner assembly, a fuel line extending between the fuel intake tube and the burner assembly, and a preheater located within the fuel tank interior volume, the preheater including a heating element proximate the inlet end of the fuel intake tube.

In some examples, the heating element extends in a direction that is generally orthogonal to a length of the fuel intake tube.

In some examples, the heating element is an electric heating element.

In some examples, the heating element extends in a direction that is generally parallel to a bottom surface of the fuel tank.

In some examples, the portable heater further includes a thermostatic controller and a temperature sensor located in the fuel tank, wherein the thermostatic controller activates the heating element based on a temperature sensed at the temperature sensor.

In some examples, the temperature sensor is located proximate the inlet end of the fuel intake tube.

In some examples, the thermostatic controller operates the heating element to maintain the liquid fuel even when the burner assembly is deactivated.

In some examples, the thermostatic controller operates the heating element at a first heating output when the temperature sensor senses a fuel temperature below a predetermined threshold and wherein the thermostatic controller operates the heating element at a second heating output when the temperature sensor senses a fuel temperature at or above the predetermined threshold, wherein the second heating output is lower than the first heating output.

In some examples, the second heating output is equal to zero.

In some examples, the first heating output is a maximum heating output of the heating element.

In some examples, the predetermined threshold is 32 degrees Fahrenheit.

A preheater system for a portable heater can include an electric heating element including a vertical portion and a horizontal portion, a thermostatic controller for activating the heating element, and a temperature sensor connected to the thermostatic controller.

In some examples, the thermostatic controller operates the heating element at a first heating output when the temperature sensor senses a fuel temperature below a predetermined threshold and wherein the thermostatic controller operates the heating element at a second heating output when the temperature sensor senses a fuel temperature at or above the predetermined threshold, wherein the second heating output is lower than the first heating output.

In some examples, the second heating output is equal to zero.

In some examples, the first heating output is a maximum heating output of the heating element.

In some examples, the predetermined threshold is 32 degrees Fahrenheit.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is below.

FIG. 1 is a perspective view of a first example of a portable heater having features in accordance with the present disclosure.

FIG. 2 is an exploded perspective view of the portable heater shown in FIG. 1.

FIG. 3 is a side view of the portable heater shown in FIG. 1.

FIG. 4 is a cross-sectional side view of the portable heater shown in FIG. 1.

FIG. 5 is an end view of the portable heater shown in FIG. 1.

FIG. 6 is a cross-sectional end view of the portable heater shown in FIG. 1.

FIG. 7 is a perspective view of a portion of the portable heater shown in FIG. 1 illustrating a portion of a fuel delivery system.

FIG. 8 is a perspective view of the fuel delivery system shown in FIG. 7.

FIG. 9 is a perspective view of a portion of the portable heater shown in FIG. 1 illustrating a portion of a second example of a fuel delivery system.

FIG. 10 is a perspective view of the fuel delivery system shown in FIG. 9.

FIG. 11 is a perspective view of a second example of a portable heater having features in accordance with the present disclosure.

FIG. 12 is an exploded perspective view of the portable heater shown in FIG. 11.

FIG. 13 is a side view of the portable heater shown in FIG. 11.

FIG. 14 is a cross-sectional side view of the portable heater shown in FIG. 11.

FIG. 15 is an end view of the portable heater shown in FIG. 11.

FIG. 16 is a cross-sectional end view of the portable heater shown in FIG. 11.

FIG. 17 is a perspective view of a portion of the portable heater shown in FIG. 11 illustrating a portion of a fuel delivery system.

FIG. 18 is a perspective view of the fuel delivery system shown in FIG. 17.

FIG. 19 is a perspective view of a portion of the portable heater shown in FIG. 11 illustrating a portion of a second example of a fuel delivery system.

FIG. 20 is a perspective view of the fuel delivery system shown in FIG. 19.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims. Referring to the drawings wherein like reference numbers correspond to like or similar components throughout the several figures.

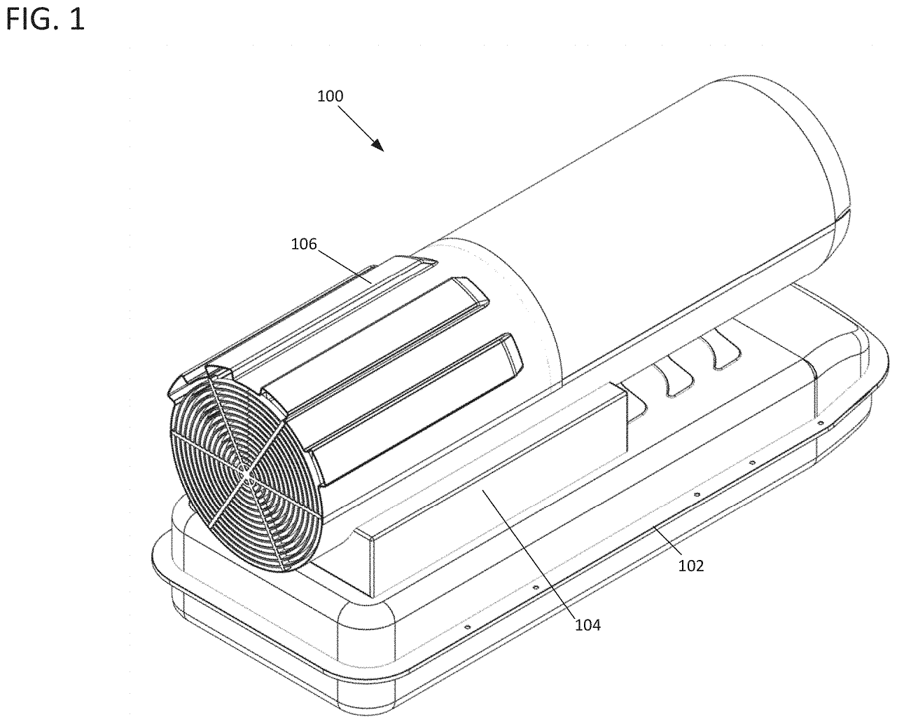

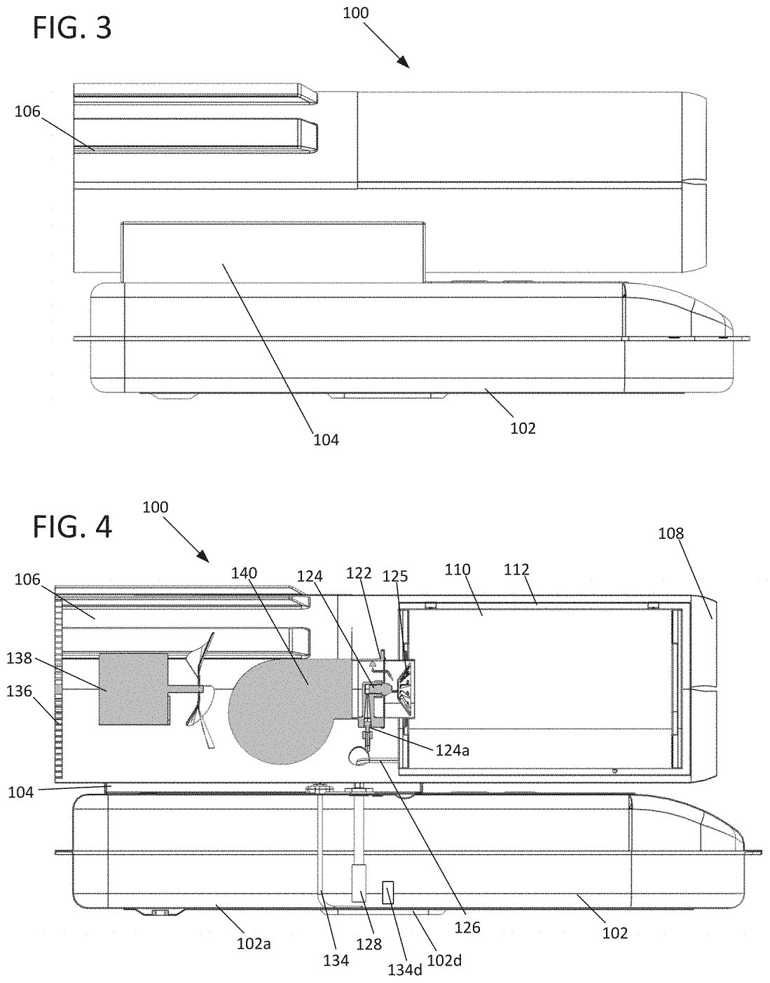

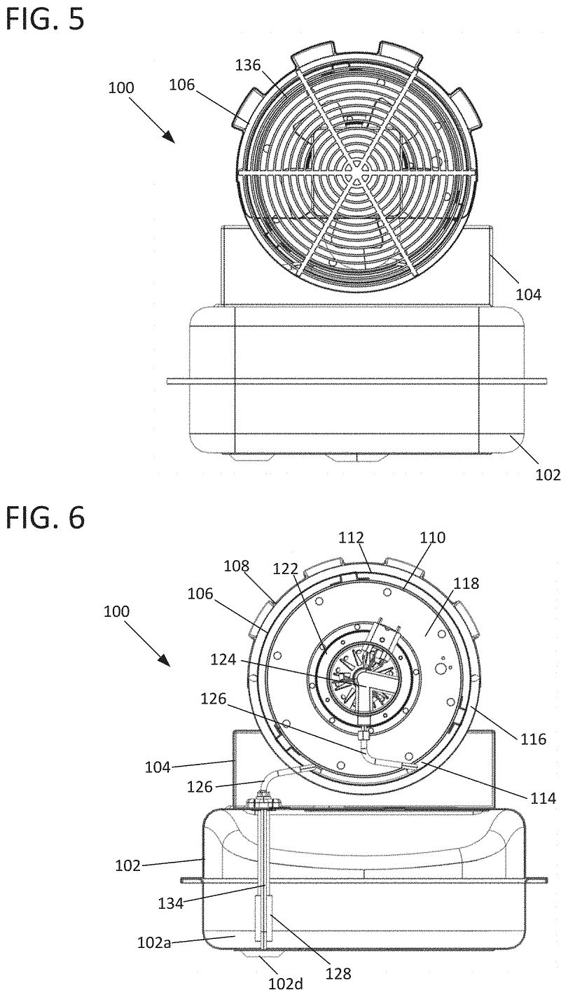

Referring to FIGS. 1 to 10, a portable heater 100 is shown. As shown, the portable heater 100 includes a fuel tank 102 defining an interior volume 102a within which liquid fuel, for example kerosene or diesel, can be stored. The portable heater 100 is also shown as including a base frame 104 and a heater assembly 106. The base frame 104 is mounted to the fuel tank 102 and supports the heater assembly 106.

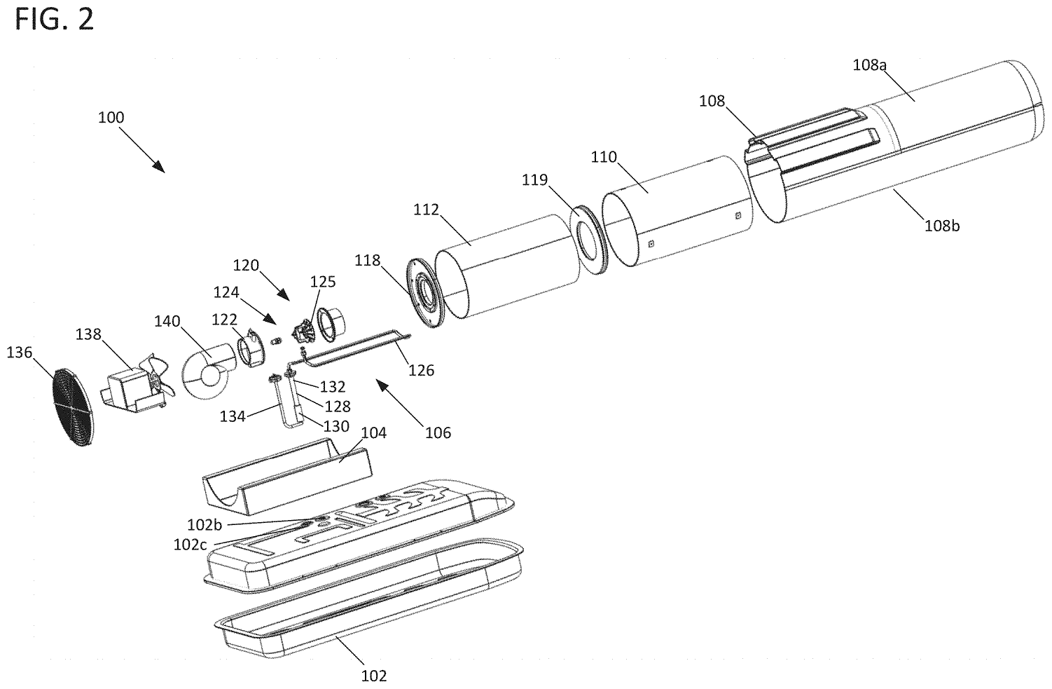

As most easily seen at FIG. 2, the heater assembly 106 is shown as including a tubular outer heat shield 108, a combustion chamber outer shell 110, and a combustion chamber inner shell 110. When assembled, the outer heat shield 108, the shell 110, and the shell 112 are coaxially aligned and arranged such that the inner shell 110 is located within and spaced from the outer shell 112 and such that the inner and outer shells 110, 112 reside within and are spaced from the tubular outer heat shield 108. With such an orientation, a first interstitial space or air gap 114 is formed between the inner and outer shells 110, 112 and a second interstitial space or gap 116 is formed between the outer shell 112 and the heat shield 108. Stand-offs or other support structures can be provided to support the outer shell 112 within the heat shield 108 and to support the inner shell 110 within the outer shell 112. In the example shown, the tubular outer heat shield 108 is formed from a first half shell 108a and a second half shell 108b, while the inner and outer shells 110, 112 are each formed from a single sheet welded at a seam. Other configurations are possible.

The heater assembly 106 is also shown as including a rear ring 118 mounted at an inlet end of the combustion chamber inner shell 110 and a front ring 119 mounted at the opposite end of the shell 110. The rear ring 118 supports a burner assembly 120 which is shown as including an air pump 140, a burner mount 122, a nozzle head assembly 124, and a mixer or blender 125. In one aspect, the nozzle head 124 includes a fuel inlet port 124a and an outlet port 124b. The nozzle head 124 is secured to the burner mount 122 with the burner mount 122 including ignition and other control components. The nozzle head fuel inlet port 124a is connected to a fuel line 126, which in turn extends to a fuel intake assembly 128. As shown, the fuel intake assembly 128 extends through and is secured at an opening 102b in the fuel tank 102 and extends into the interior volume 102a of the fuel tank 102. The fuel intake assembly 128 is shown as including a fuel filter 130 at an inlet end 128a of the fuel intake assembly 128 and a main tube 132. The heater assembly 106 is also shown as including a fan 138 for drawing air through the intake grille 136, and through the interstitial space or gap 114 between the inner and outer tubes 110, 112 such that heated air is provided in a forced air arrangement.

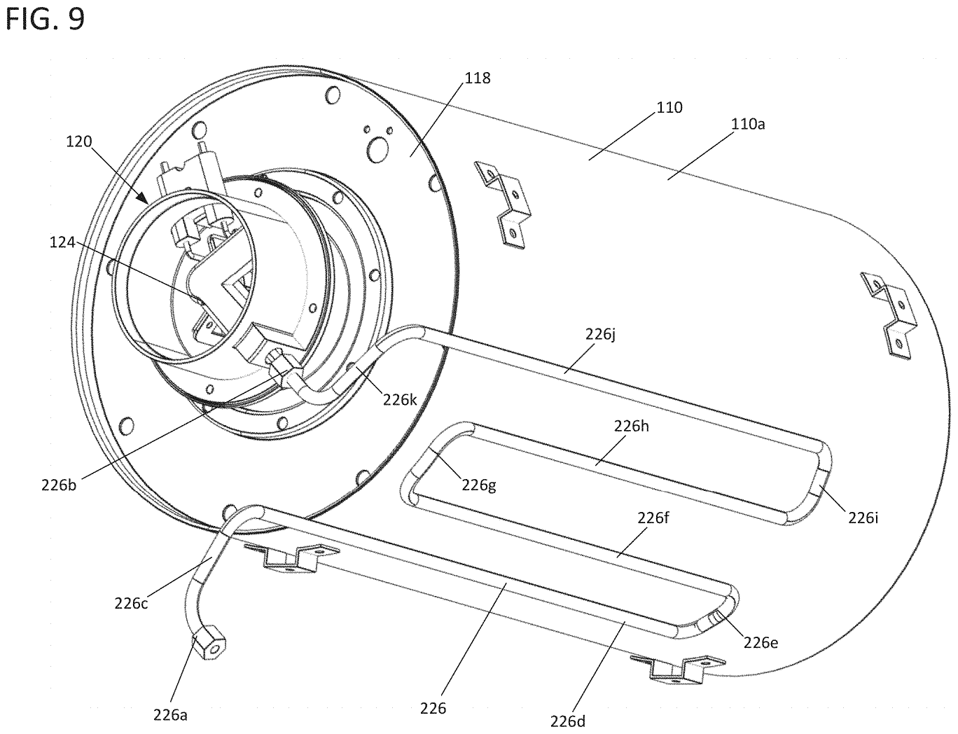

In the example shown, the heater assembly 106 is also shown as including a preheater 134 with an electric heating element 134a located proximate the fuel intake assembly inlet end 128a and fuel filter 130. In one aspect, the electric heating element 134a is configured as an immersion heater and extends in a direction that is parallel to a bottom of the fuel tank 102. The electric heating element 134a is shown as being connected to electrical leads 134b, which can in turn be connected to a power source and/or a control unit 134c. The control unit 134c, which could be a thermostatic controller, a relay or a control knob, can be provided to selectively power the electric heating element 134a. As shown at FIG. 9, a temperature sensor 134d is also provided that is connected to the control unit 134c. The temperature sensor 134d can be installed in the fuel tank, for example proximate the fuel intake tube inlet end 128a as shown at FIG. 4. A standard AC power source can be provided to the portable heater 100 to power the fan 138, blower 140, and the control unit 134c, which in turn provides power to the electric heating element 134a. In one example, the control unit 134c remains operative to maintain the fuel temperature with the heating element 134a as long as the portable heater 100 is plugged in to a power source, even when the portable heater 100 is turned off or otherwise deactivated. Such a configuration allows for the portable heater 100 to be used immediately after periods of non-use since the fuel has been maintained at a temperature that is satisfactory for combustion.

The preheater 134 functions to heat fuel proximate the inlet end 128a of the fuel intake assembly 128 during cold outdoor air temperatures when it is possible that fuel within the fuel tank 102 has undesirably gelled. By providing heat at this location, the fuel can be heated to low the viscosity of the fuel sufficiently to flow through the fuel filter 130 and through the fuel line 126. In one aspect, the fuel tank 102 is shown as being provided with a well or sump 102d into which the heating element 134a extends. The well or sump 102d can help to concentrate the heating effect of the heating element 134a to heat the fuel within the well or sump 102d such that a region of lower viscosity fuel is provided that can flow into the fuel filter 130. As this fuel is drawn into the fuel filter 130, more fuel is drawn into the well or sump 102d and is again heated in a concentrated fashion to improve operation of the portable heater 100.

In one aspect, preheater 134 is provided with controls, for example a thermostatic controller, enabling the preheater 134 to determine the fuel temperature and to self-regulate to maintain relatively constant diesel/kerosene temperature near the fuel pickup tube proximate the inlet end 128a of the fuel intake assembly 128. When the fuel temperature is below freezing temperature or a pre-determined temperature, the preheater 134 will power the heating element 134a to its maximum level or 100%. The heat output of the preheater 134 may be selected based upon the tank size and maximum fuel capacity. When the diesel fuel temperature in the tank 100 reaches to a preset temperature, for example 75° F., the preheater 134 will reduce the heat output of the heating element 134a to below the maximum level to a minimum level. In one example, the minimum level is 0% output. This configuration enables the fuel intake assembly 128 to receive fuel from the tank 100 at a near constant viscosity. In one aspect, the electric heating element 134a will have a non-corrosive outer jacket, for example a nickel-based alloy, to prevent corrosion.

The heater assembly 106 is also shown as including an intake grill 136 secured to the tubular heat shield 108. The intake grille 136 functions to prevent unwanted debris from entering the heater assembly 106.

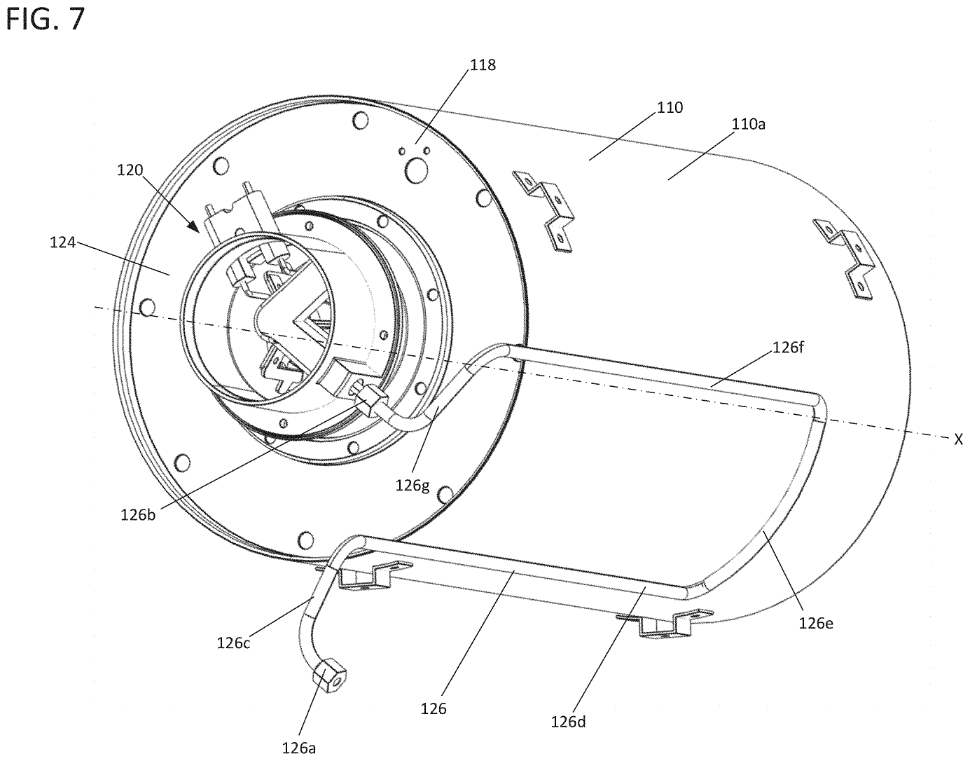

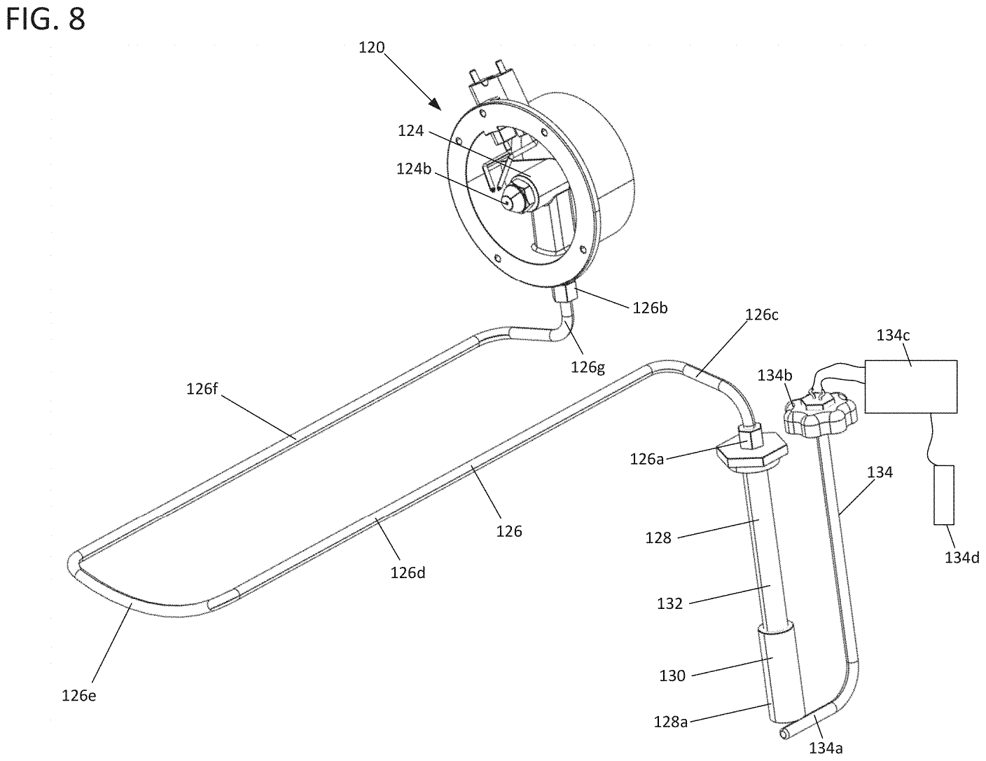

As most easily viewed at FIGS. 7 and 8, the fuel line 126 extends from an inlet end 126a to an outlet end 126b and includes a first transition segment 126c, a first lengthwise segment 126d, a first transverse segment 126e, a second lengthwise segment 126f, and a second transition segment 126g. In one aspect, the segments 126d, 126e, 126f each extend along an exterior side 110a of the combustion chamber inner chamber 110. The first and second lengthwise segments 126d, 126f are shown as being parallel and extending in a direction parallel to the length of the inner chamber 110 which is also parallel to the longitudinal axis X about which the inner chamber 110, the outer chamber 112, and the tubular heat shield 108 are coaxially aligned. The first transverse segment 126e joins the first and second lengthwise segments 126d, 126f and extends in a direction that is transverse or orthogonal to the first and second lengthwise segments 126d, 126f, the length of the inner chamber 110, and the axis X. In one aspect, the transverse segment 126e has an arc shape that is complementary to the shape of the inner chamber 110. As a result, the portion of the fuel line 126 adjacent the inner chamber 110 has a generally complementary arc shape (e.g. from the view shown at FIG. 6) to the surface of the inner chamber 110. As shown, the segments 126d, 126e, 126f are spaced slightly from the exterior side 110a of the inner chamber 110 by a small air gap. However, the segments 126d, 126e, 126f could be placed in direct contact with the inner chamber 110. The segments 126d, 126e, and/or 126f can also be secured to the inner chamber 110 with mechanical fasteners, such as clips, or can be self-supporting (or supported by another structure) such that no physical connection exists between the fuel line 126 and the inner chamber 110. In one aspect, the first and second lengthwise segments 126d, 126f have a length that is a majority of the length of the inner chamber 110.

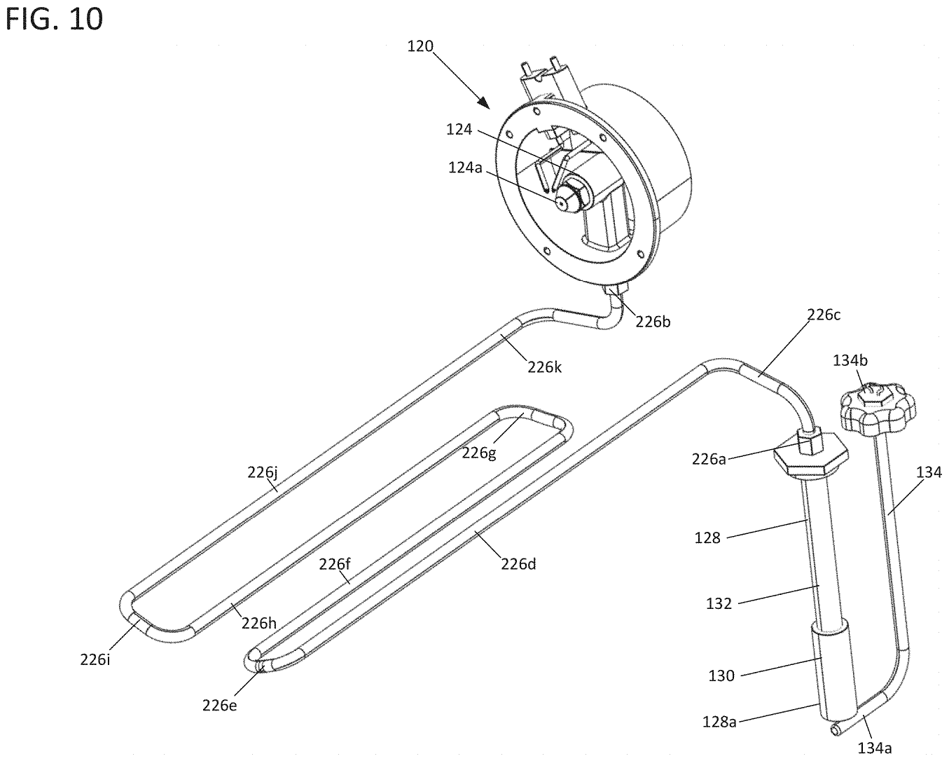

Although the fuel line 126 is shown with three segments 126d, 126e, 126f extending along the outer surface 110a of the inner chamber 110 to result in a first heated length of fuel line, the fuel line 126 can be configured with any number of segments and bends to obtain a desired length of tubing to be heated by the inner chamber 110. One such variation is shown at FIGS. 9 and 10, wherein an alternative example of a fuel line 226 is presented. In the example shown, the fuel line 226 has generally double the total heated length of fuel line, in comparison to the embodiment shown at FIGS. 7 and 8. In the example shown at FIGS. 9 and 10, the fuel line 226 extends between a first end 226a and a second end 226b and includes a first transition segment 226c, a first lengthwise segment 226d, a first transverse segment 126e, a second lengthwise segment 226f, a second transverse segment 226g, a third lengthwise segment 226h, a third transverse segment 226i, a fourth lengthwise segment 226j, and a second transition segment 226k. As such, the fuel line 226 has four parallel lengthwise segments that are each the majority of the length of the combustion chamber inner chamber 110. Further variations for achieving a desired total heated length of fuel line are possible, for example, the fuel line can be bent to have a serpentine or coiled shape. The fuel line can also have multiple parallel transverse segments that form a majority of the heated length of fuel line rather than the shown configuration with longer lengthwise segments.

In operation, fuel from the fuel tank 102 is drawn through the fuel filter 130, through the fuel filter 130, through the main tube 132, through the fuel line 126 (or 226), and into the burner assembly nozzle head 124, at which point the fuel is vaporized, mixed with air from the air pump 140 and dispersed at the outlet 124c. The leaving fuel-air mixture is then ignited by the ignition components of the burner mount 122 such that a flame extends into the combustion chamber inner chamber 110. Accordingly, the combustion chamber inner chamber 110 is heated by the flame and in turn heats air flowing through the interstitial space or gap 114 between the inner and outer tubes 110, 112. As a portion of the fuel line 126 (or 226) extends along the outer surface 110a of the inner chamber 110 and resides within the interstitial space or gap 114 between the inner and outer tubes 110, 112, the fuel line 126 is likewise heated by the combustion of the fuel. As fuel travels through the heated length (e.g. 126d-126f, 226d-226j) of the fuel line 126, the fuel is heated within the fuel line 126 before the fuel reaches the nozzle head 124. By preheating the fuel in this manner, the fuel can be more effectively vaporized in the nozzle head 124 which results in more efficient combustion of the fuel. Additionally, the disclosed system can preheat the fuel sufficiently such that the fuel temperature is increased and the fuel viscosity is lowered to a point where the burner assembly 120 can operate to combust the fuel in cold climate conditions where operation of the system might not be possible otherwise. The use of the preheater 134 can also be used in conjunction with this approach to further enable operation during cold conditions, particularly at start up when fuel flow into the fuel line 126 needs to be initiated.

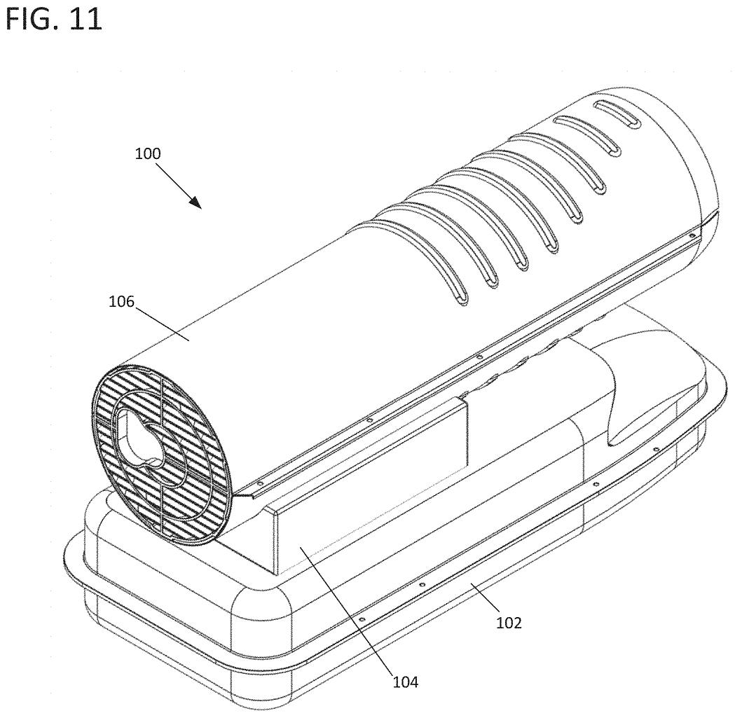

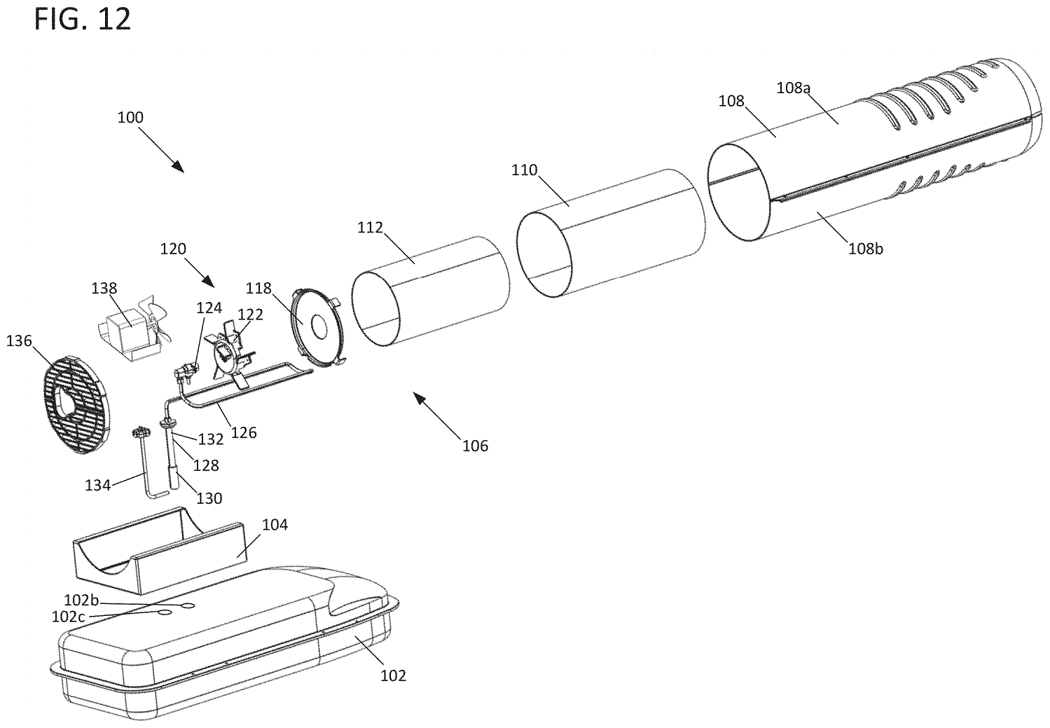

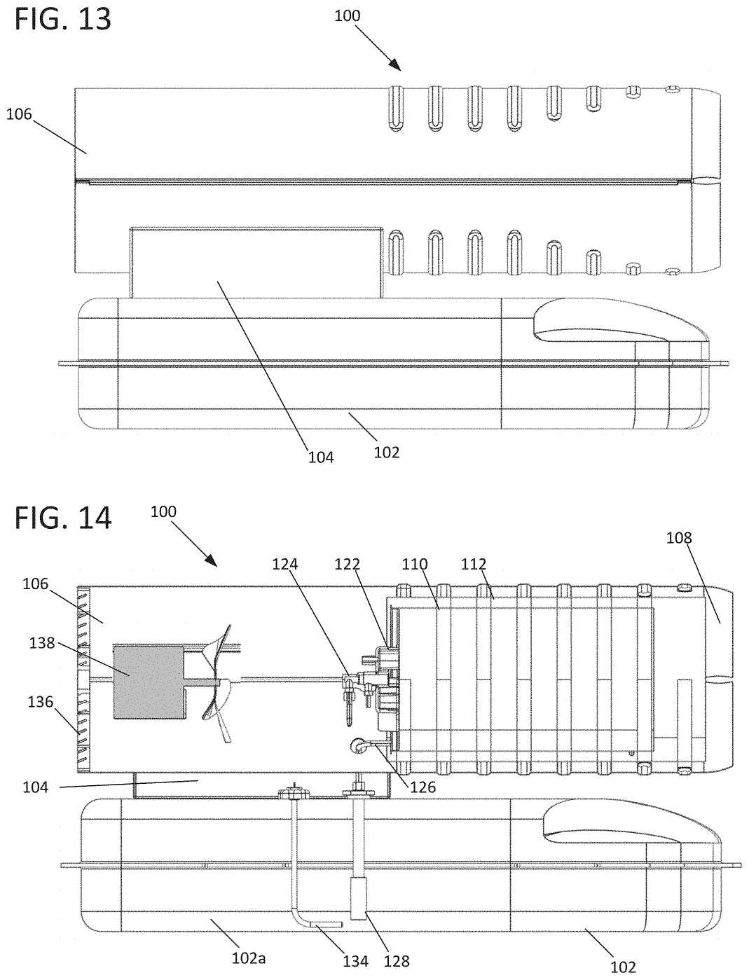

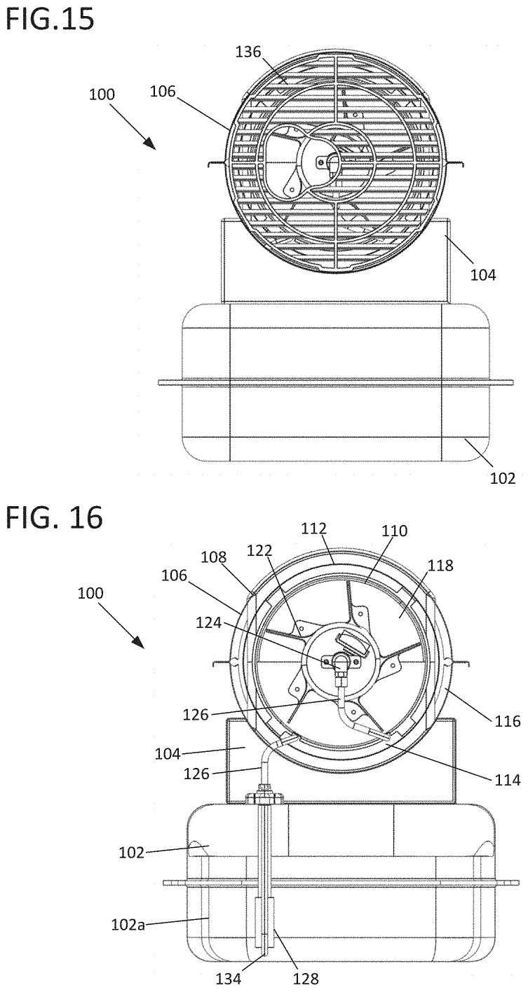

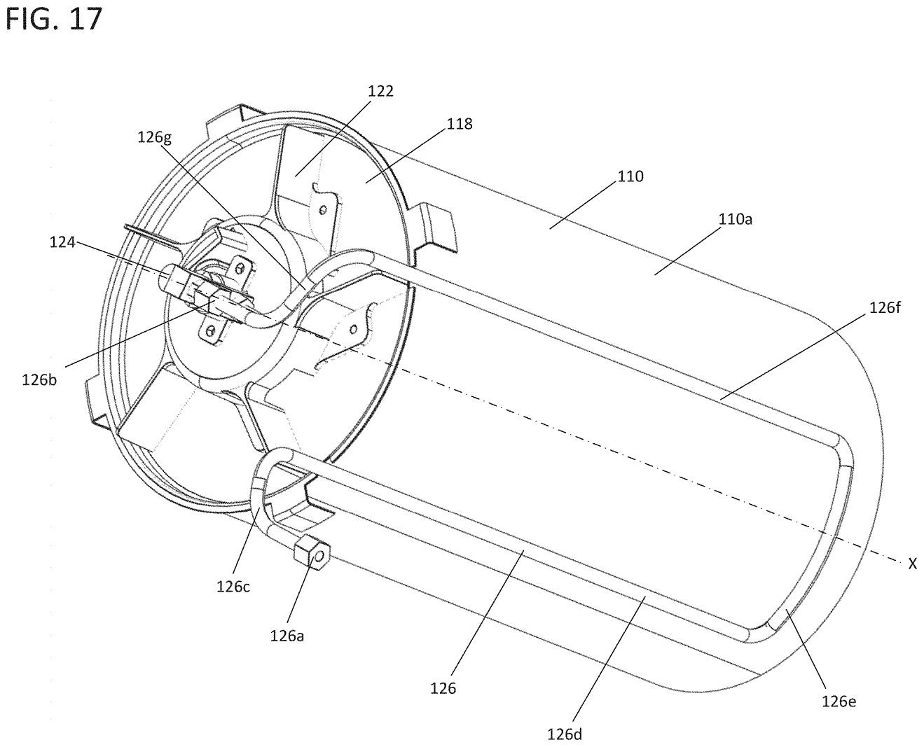

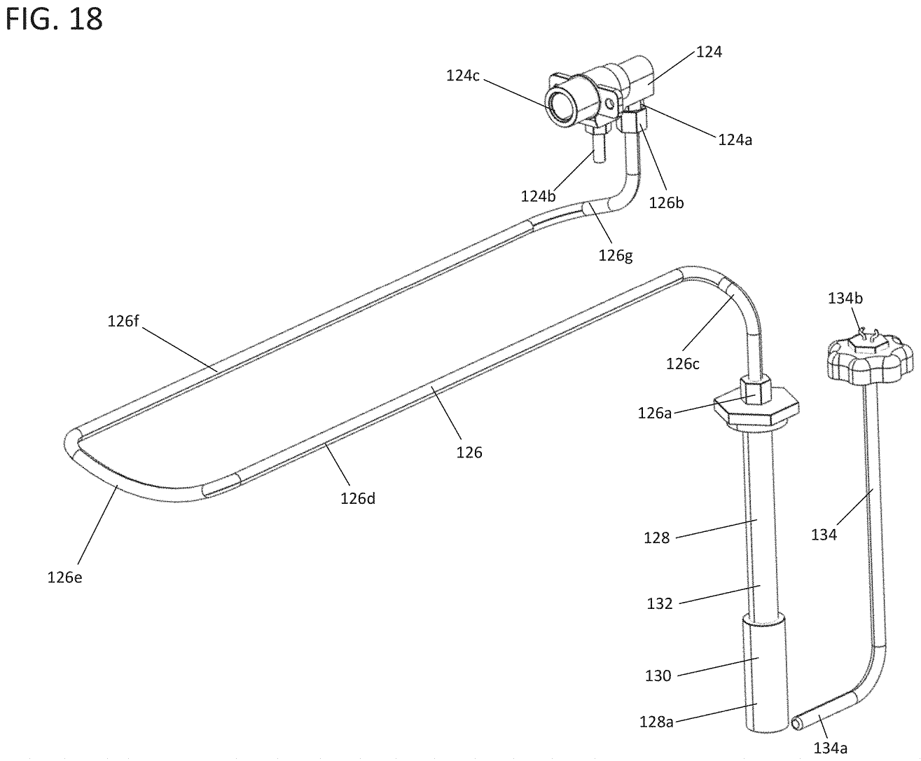

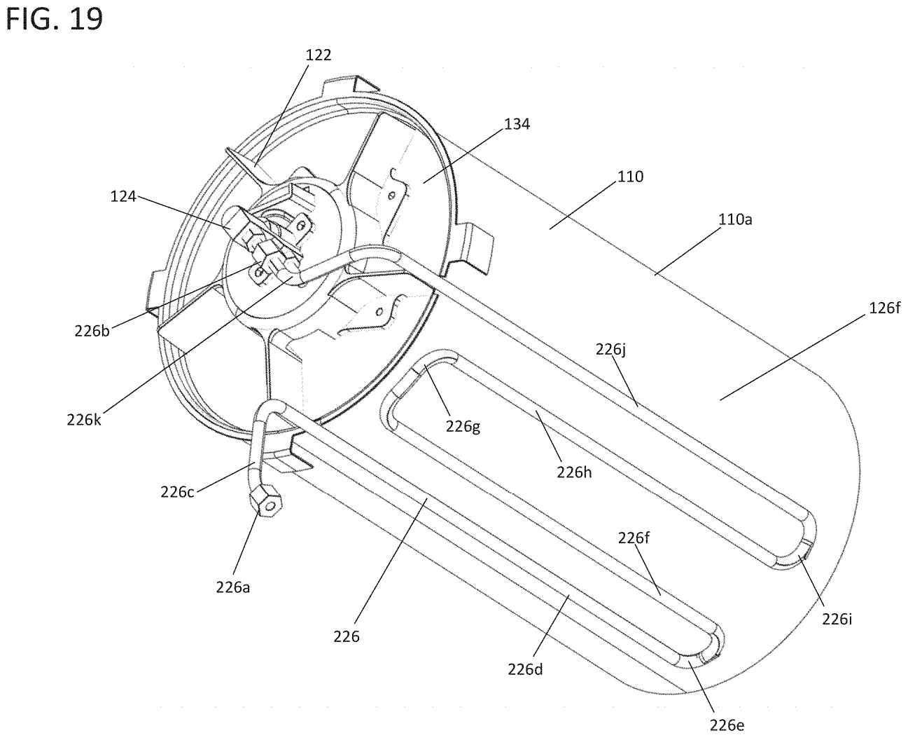

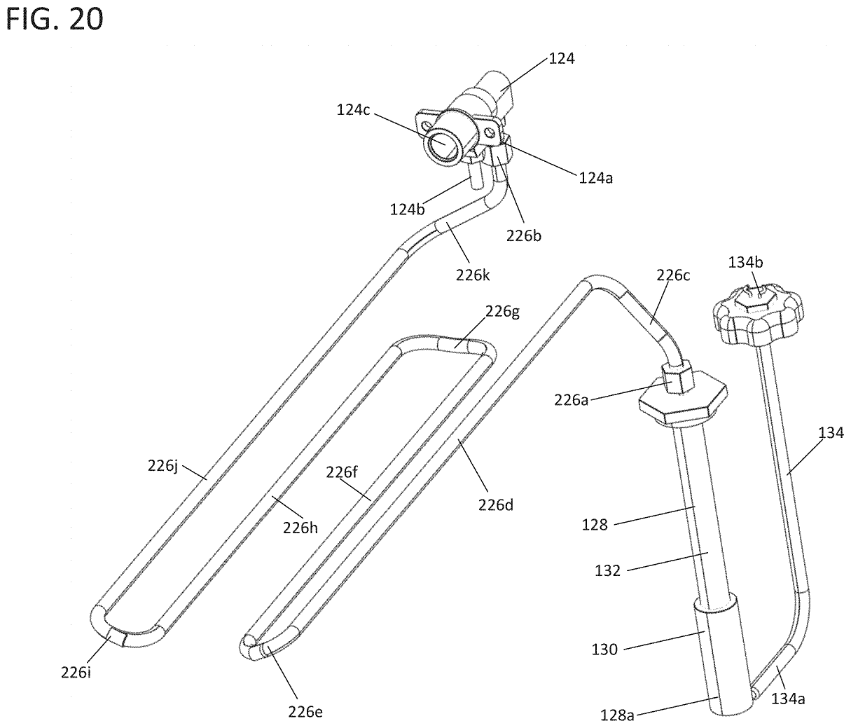

Referring to FIGS. 11-20, an additional portable heater embodiment is disclosed that utilizes the same preheating approach of preheating the fuel at the inlet with an electric preheater 134 and within the fuel line about the combustion chamber inner tube 110, as described above. Accordingly, the above description is fully applicable to the embodiments of FIGS. 11-20 and similar reference numbers will therefore be used. The primary difference between the embodiments of FIGS. 1-10 and FIGS. 11-20 is that the embodiment of FIGS. 11-20 does not include the powered blower 140 and related components that create a forced air configuration for the burner of the portable heater 100. Rather, the portable heater 100 of FIGS. 11-20 relies on a modified burner mount 122, configured for atmospheric combustion at the burner assembly nozzle 124, and relies only on the fan 138 for providing combustion air to the chamber and for drawing fuel into the burner assembly nozzle 124. The portable heater 100 of FIGS. 11-20 also does not include the front ring 119 provided for the embodiment shown at FIGS. 1-10.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed is:

1. A portable heater comprising:
a. a fuel tank;
b. a burner assembly; and
c. a combustion chamber tube; and
d. a fuel line extending between the fuel tank and the burner assembly, wherein, during operation, at least a portion of the fuel line is heated by the combustion chamber tube.

2. The portable heater of claim 1, wherein the at least a portion of the fuel line extends along an exterior side of the combustion chamber tube.

3. The portable heater of claim 2, wherein the at least a portion of the fuel line is in direct contact with the exterior side of the combustion chamber tube.

4. The portable heater of claim 2, wherein the at least a portion of the fuel line is spaced from the exterior side of the combustion chamber tube.

5. The portable heater of claim 1, wherein the combustion chamber tube is an inner tube disposed within an outer combustion chamber tube, and wherein the at least a portion of the fuel line extends in an interstitial space defined between the combustion chamber inner and outer tubes.

6. The portable heater of claim 1, wherein a first segment of the at least a portion of the fuel line extends in a direction parallel to a length of the combustion chamber tube.

7. The portable heater of claim 6, wherein the fuel line includes two or more first segments.

8. The portable heater of claim 7, wherein the fuel line includes four first segments.

9. The portable heater of claim 1, further including a fuel intake tube located within an interior volume of the fuel tank and including a preheater located within the fuel tank interior volume, the fuel intake tube being in fluid communication with the fuel line, the preheater including a heating element proximate an inlet end of the fuel intake tube.

10. The portable heater of claim 9, wherein the preheater heating element is an electric heating element.

11. A portable kerosene heater comprising:
a. a fuel tank for storing kerosene;
b. a heater assembly supported to the fuel tank, the heater assembly including a burner assembly and a combustion chamber tube; and
c. a fuel line extending between the fuel tank and the burner assembly and along an exterior side of the combustion chamber tube.

12. The portable kerosene heater of claim 11, wherein at least a portion of the fuel line is in direct contact with the exterior side of the combustion chamber tube.

13. The portable kerosene heater of claim 11, wherein at least a portion of the fuel line is spaced from the exterior side of the combustion chamber tube.

14. The portable kerosene heater of claim 11, wherein the combustion chamber tube is an inner tube disposed within an outer combustion chamber tube, and wherein at least a portion of the fuel line extends in an interstitial space defined between the combustion chamber inner and outer tubes.

15. The portable kerosene heater of claim 14, wherein a first segment of the at least a portion of the fuel line extends in a direction parallel to a length of the combustion chamber tube.

16. The portable kerosene heater of claim 15, wherein the fuel line includes two or more first segments.

17. The portable kerosene heater of claim 16, wherein the fuel line includes four first segments.

18. The portable kerosene heater of claim 11, further including a fuel intake tube located within an interior volume of the fuel tank and including a preheater located within the fuel tank interior volume, the fuel intake tube being in fluid communication with the fuel line, the preheater including a heating element proximate an inlet end of the fuel intake tube.

19. The portable kerosene heater of claim 9, wherein the preheater heating element is an electric heating element.

20. A portable heater comprising:
a. a fuel tank defining an interior volume for storing a liquid fuel;
b. a fuel intake tube located within the interior volume of the fuel tank, the fuel intake tube having an inlet end;
c. a burner assembly for combusting the fuel;
d. a fuel line extending between the fuel intake tube and the burner assembly; and
e. a preheater located within the fuel tank interior volume, the preheater including a heating element proximate the inlet end of the fuel intake tube.

21. The portable heater of claim 20, wherein the heating element extends in a direction that is generally orthogonal to a length of the fuel intake tube.

22. The portable heater of claim 20, wherein the heating element is an electric heating element.

23. The portable heater of claim 20, wherein the heating element extends in a direction that is generally parallel to a bottom surface of the fuel tank.

24. The portable heater of claim 20, further including a thermostatic controller and a temperature sensor located in the fuel tank, wherein the thermostatic controller activates the heating element based on a temperature sensed at the temperature sensor.

25. The portable heater of claim 24, wherein the temperature sensor is located proximate the inlet end of the fuel intake tube.

26. The portable heater of claim 24, wherein the thermostatic controller operates the heating element to maintain the liquid fuel even when the burner assembly is deactivated.

27. The portable heater of claim 24, wherein the thermostatic controller operates the heating element at a first heating output when the temperature sensor senses a fuel temperature below a predetermined threshold and wherein the thermostatic controller operates the heating element at a second heating output when the temperature sensor senses a fuel temperature at or above the predetermined threshold, wherein the second heating output is lower than the first heating output.

28. The portable heater of claim 27, wherein the second heating output is equal to zero.

29. The portable heater of claim 28, wherein the first heating output is a maximum heating output of the heating element.

30. The portable heater of claim 28, wherein the predetermined threshold is 32 degrees Fahrenheit.

31. A preheater system for a portable heater comprising:
a. an electric heating element including a vertical portion and a horizontal portion;
b. a thermostatic controller for activating the heating element; and
c. a temperature sensor connected to the thermostatic controller.

32. The preheater system of claim 31, wherein the thermostatic controller operates the heating element at a first heating output when the temperature sensor senses a fuel temperature below a predetermined threshold and wherein the thermostatic controller operates the heating element at a second heating output when the temperature sensor senses a fuel temperature at or above the predetermined threshold, wherein the second heating output is lower than the first heating output.

33. The preheater system of claim 32, wherein the second heating output is equal to zero.

34. The preheater system of claim 32, wherein the first heating output is a maximum heating output of the heating element.

35. The preheater system of claim 32, wherein the predetermined threshold is 32 degrees Fahrenheit.
